(19) United States
(12) Patent Application Publication
(10) Pub. No.: US 2013/0238389 A1
(43) Pub. Date: Sep. 12, 2013

(54) INFORMATION PROCESSING DEVICE, AN INFORMATION PROCESSING METHOD AND AN INFORMATION PROCESSING METHOD

(71) Applicant: Haruka Yoshida, Tokyo (JP)

(72) Inventor: Haruka Yoshida, Tokyo (JP)

(73) Assignee: NEC Corporation, Tokyo (JP)

(21) Appl. No.: 13/988,393

(22) PCT Filed: Nov. 14, 2011
(86) PCT No.: PCT/JP2011/076608

§ 371 Date: May 20, 2013

(30) Foreign Application Priority Data
Nov. 22, 2010 (JP) 2010-260167

(51) Int. Cl. G06Q 10/06

(52) U.S. Cl. CPC G06Q 10/0635
USPC 705/7.28

(57) ABSTRACT

When a problem occurs in a system, an evaluation as to whether or not an important information service or an important person receiving the service is influenced, and an evaluation of the degree of the influence, are performed. Accordingly, an information processing device for notifying an information service providing state is provided with: an acquisition unit for acquiring measurement values regarding monitoring target items relating to the information service; an importance degree calculation unit for calculating the degree of importance regarding the information service or a person receiving the service; a determination unit for determining a degree of violation of the conditions, by comparing the measurement values with a plurality of conditions required in relation to the monitoring target items relating to the information service; and an image generation unit for generating an image indicating the degrees of violation of the conditions.

### TECHNICAL FIELD

The present invention relates to a technology which manages an information service or a service recipient.

### BACKGROUND ART

In recent years, the number of organizations and the number of enterprises which utilize an information system for business are increasing. A service provider who provides the information service for those organizations and enterprises needs to manage service quality intensively according to their needs for each of the service recipients.

Specifically, a business manager of the service provider or administrator of service needs to confirm preferentially whether services are provided with proper quality to a so-called excellent service recipient. If there is a certain problem, the business manager of the service provider or administrator of service will need to handle it immediately and appropriately. The excellent service recipient means a service recipient who contracts many expensive rank services of the company with or who has transactions over a long term. And conversely, services of the company, which are under contract with a plurality of important service recipients are important services. For such services, necessity of countermeasures against a problem at the time of the problem occurrence needs to be confirmed with priority over other services.

Concerning the requirement mentioned above, patent document 1 discloses a technology which determines sufficiency degree for contract information of services. On the other hand, patent document 2 discloses a method to analyze a computer infrastructure having a plurality of components which provide services. Patent document 2 discloses a technology in which, for an identical service, a plurality of different service level targets is set for each service recipient, and which specifies a service component which needs modification, on the service component.

Also, patent document 3 discloses a method to analyze a computer infrastructure having a plurality of components which provide services. Patent document 3 discloses a method which, particularly in case where services are provided to a plurality of service recipients, detects, within an identical service, a service recipient for whom a degree of satisfaction is realized 100% and a service recipient for whom it is not. And patent document 3 discloses a method which, by restricting services to the service recipient for whom excessive degree of satisfaction is realized, improves service quality to the service recipient for whom the degree of satisfaction is insufficient.

Patent document 1: Japanese Unexamined Patent Application Publication No. 2001-320370

Patent document 2: Japanese Unexamined Patent Application Publication No. 2008-108262

Patent document 3: Japanese Unexamined Patent Application Publication No. H09-244973

### DISCLOSURE OF THE INVENTION

### Problems to be Solved by the Invention

However, in the prior art mentioned above, in case a plurality of different services is provided to a plurality of service recipients, there were no indexes for prioritizing which service recipient or services are important.

### Measures for Solving the Problems

In order to achieve the object mentioned above, a device according to the present invention is an information processing device for notifying a providing state of an information service, and characterized in that it includes: an acquisition means for acquiring measurement values regarding monitoring target items relating to the information service; an importance degree calculation means for calculating an importance degree of the information service or an information service recipient; a determination means for comparing a plurality of conditions required in relation to the monitoring target items relating to the information service with the measurement values and determining a degree of violation of the conditions; and an image generation means for generating an image indicating the degree of violation of the conditions for each different importance degree of the information service or the information service recipient.

In order to achieve the object mentioned above, a method according to the present invention is a data processing method for notifying a providing state of an information service, and characterized in that it includes: a step for acquiring measurement values regarding monitoring target items relating to the information service; a step for calculating an importance degree of the information service or an information service recipient; a step for comparing a plurality of conditions required in relation to the monitoring target items relating to the information service with the measurement values and determining a degree of violation of the conditions; and a step for generating an image indicating the degree of violation of the conditions for each different importance degree of the information service or the information service recipient.

In order to achieve the object mentioned above, a program according to the present invention is an information processing program for notifying a providing state of an information service, and characterized in that it makes a computer execute steps including: a step for acquiring measurement values regarding monitoring target items relating to the information service; a step for calculating an importance degree of the information service or an information service recipient; a step for comparing a plurality of conditions required in relation to the monitoring target items relating to the information service with the measurement values and determining a degree of violation of the conditions; and a step for generating an image indicating the degree of violation of the conditions for each different importance degree of the information service or the information service recipient.

### Effect of the Invention

According to the present invention, influences of the occurred problem on business for the problem which occurred can be evaluated.

### BRIEF DESCRIPTION OF THE DRAWINGS

FIG. 1 is a block diagram showing a structure of an information processing device according to the first exemplary embodiment of the present invention.

FIG. 2 is a block diagram showing an exemplary structure of an importance degree calculation device according to the second exemplary embodiment of the present invention.

FIG. 3 is a figure showing an example of data registered in a service information memory unit of the importance degree calculation device according to the second exemplary embodiment of the present invention.

FIG. 4 is a figure showing an example of data outputted by an importance degree calculation unit of the importance degree calculation device according to the second exemplary embodiment of the present invention.

FIG. 5 is a figure showing an example of data outputted by the importance degree calculation unit of the importance degree calculation device according to the second exemplary embodiment of the present invention.

FIG. 6 is a figure showing an example of index measurement data acquired by the information acquisition unit of the importance degree calculation device according to the second exemplary embodiment of the present invention collected.

FIG. 7 is a figure showing an example of data drawn by a display image generation unit of the importance degree calculation device according to the second exemplary embodiment of the present invention.

FIG. 8 is a figure showing an example of data drawn by the display image generation unit of the importance degree calculation device according to the second exemplary embodiment of the present invention.

FIG. 9 is a flow chart showing a flow of processing of the importance degree calculation device according to the second exemplary embodiment of the present invention.

FIG. 10 is a figure indicating a structure between CI's which constitute services and problem occurrence status according to the second exemplary embodiment of the present invention.

FIG. 11 is a figure showing another example of data drawn by the display image generation unit of the importance degree calculation device according to the second exemplary embodiment of the present invention.

FIG. 12 is a figure showing another example of data drawn by the display image generation unit of the importance degree calculation device according to the second exemplary embodiment of the present invention.

FIG. 13 is a figure showing another example of data drawn by the display image generation unit of the importance degree calculation device according to the second exemplary embodiment of the present invention.

FIG. 14 is a figure showing another example of data drawn by the display image generation unit of the importance degree calculation device according to the second exemplary embodiment of the present invention.

### MODES FOR CARRYING OUT THE INVENTION

Hereinafter, exemplary embodiments of the present invention will be described exemplarily with reference to drawings. However, components described in the following exemplary embodiments are exemplifications to the utmost and are not for the purpose of limiting a technological scope of the present invention only to them.

(Definition of Terms)

First, before describing the exemplary embodiments of the present invention, definition of necessary terms is given.
“Information service” is an aggregate of IT functions to support a service recipient using information technology (IT). The “information service” can be evaluated for its quality by a monitoring index. The “information service” includes, for example, an installation management service of a mail system, an installation management service of a transaction processing system and so on.
“CI (Configuration Item)” is a component for realizing an IT function included in the information service. The “CI” includes, for example, a server, VM (Virtual Machine), a network device, an application, a process and so on.
“Failure” means either of: fault, malfunction of a CI, suspension of the information service due to that, phenomenon of reduced level of a monitoring index, and so on.
“SLA (Service Level Agreement)” indicates conditions for which agreement is exchanged between an information service provider and a service recipient in relation to an information service level. The “SLA” generally includes items related to such as availability, reliability and performance of the information service. For example, one in which a condition such as “during an information service period, TAT (Turn Around Time) is guaranteed to be no more than 5 seconds” is digitized is an “SLA”. Items of the SLA handled by this exemplary embodiment are those of which agreement level can be described by a numerical value. Examples of the item are: TAT, number of redundant HW (Hard Ware). Also, the SLA here is not limited to a case when a word as SLA is specified in an agreement name. The SLA here includes all the agreement conditions for which a numerical value agreement related to a guaranteed quality level of the information service is included. In other words, this exemplary embodiment handles the SLA as the conditions which are required in relation to the monitoring target items.

### The first Exemplary Embodiment

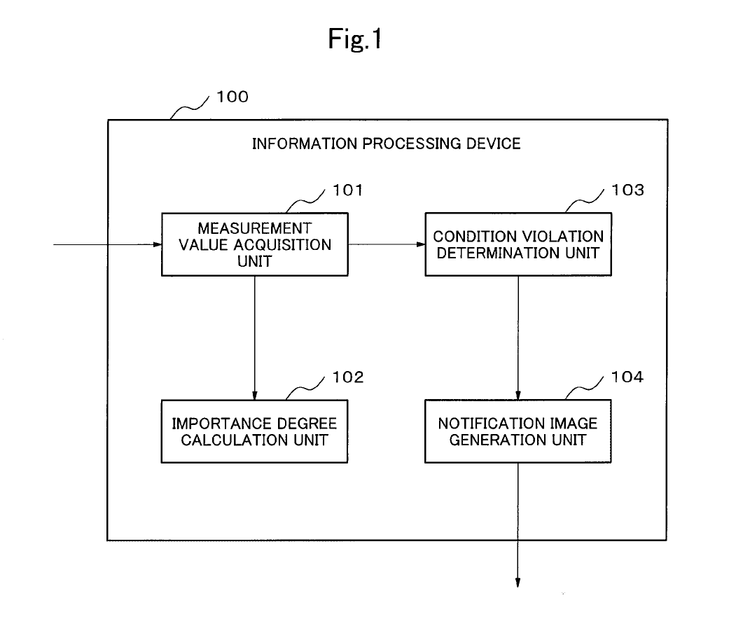

The first exemplary embodiment of the present invention will be described using FIG. 1. An information processing device 100 for notifying a providing state of an information service includes: a measurement value acquisition unit 101, an importance degree calculation unit 102, a condition violation determination unit 103 and a notification image generation unit 104.

The measurement value acquisition unit 101 acquires measurement values regarding monitoring target items relating to the information service. The importance degree calculation unit 102 calculates an importance degree of the information service or an information service recipient (“An information service recipient” is also called as “recipient of an information service”).

The condition violation determination unit 103 compares a plurality of conditions required in relation to the monitoring target items relating to the information service with the measurement values. Also, the condition violation determination unit 103 determines a degree of violation of the conditions of the measurement values.

Further, the notification image generation unit 104 generates an image indicating the degree of violation of the conditions for each different importance degree of the information service or the information service recipient.

By the structure mentioned above, the information processing device 100 can manage the information service or the service recipient by the importance degree. Therefore, by the information processing device 100, evaluation of influences as business for a problem which occurred becomes possible.

### The Second Exemplary Embodiment

The second exemplary embodiment of the present invention relates to a technology which calculates an importance degree of service or an importance degree of a service recipient. The object of carrying out this technology is to grasp status of an important service or a service recipient preferentially. This technology is effective, in particular, in a large scale system including information services, devices for providing the information serve, and many service recipients to whom the information service is provided. For each of a plurality of services, by evaluating contract amount of money, a rank and number of contracted SLA's by common indices respectively, the importance degree calculation of the service concerned is being performed. Also, for each of a plurality of service recipients, by putting together the contract amount of money, the number of SLA and the service rank in one index, the importance degree calculation of the service recipient is performed.

<<Structure>>

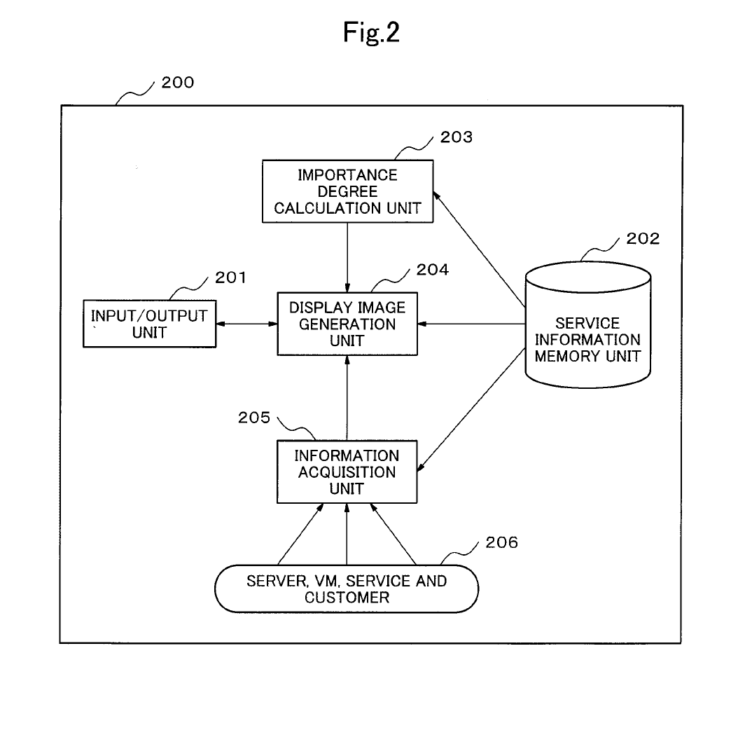

FIG. 2 is a block diagram indicating a structure of an importance degree calculation device 200 as an information processing device according to this exemplary embodiment. The importance degree calculation device 200 shown in FIG. 2 includes an input/output unit 201, a service information memory unit 202, an importance degree calculation unit 203, a display image generation unit 204 and an information acquisition unit 205.

First, the input/output unit 201 includes an input device such as a mouse and a keyboard and an output device such as a display.

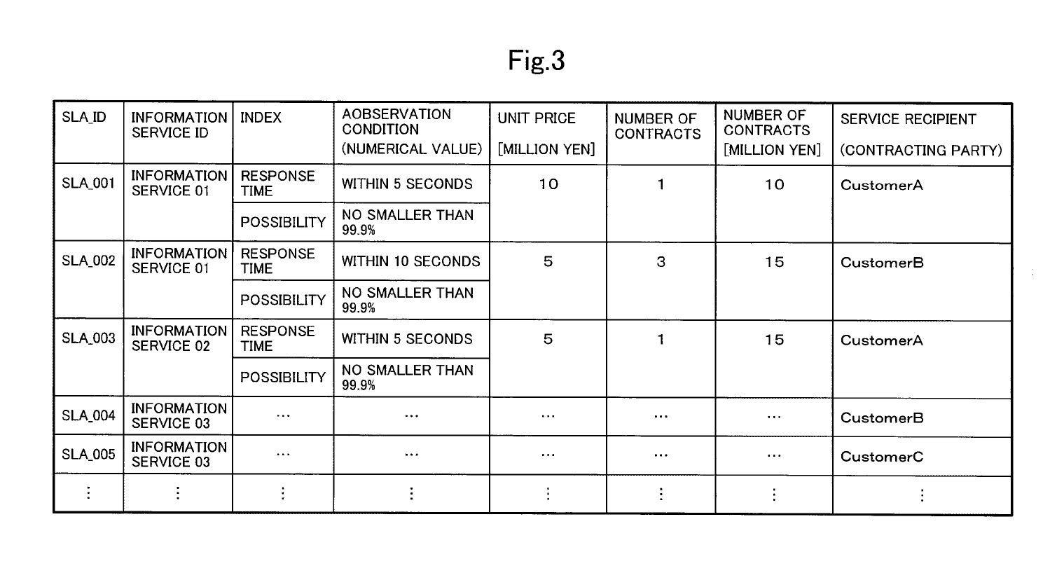

The service information memory unit 202 performs linking of an information service and an SLA, and of an information service and a service recipient. Also, in the service information memory unit 202, information of the rank and the contract amount of money for each SLA are registered. Also, in the service information memory unit 202, linking information of the information service and the CI's which constitute the information service are also registered. For example, the service information memory unit 202 stores information in plural which shows contents of each SLA such as SLA's shown in a table 301 of FIG. 3.

The importance degree calculation unit 203 calculates, based on at least either one of: a contract rank of the information service, amount of money and a number of contracts registered in the service information memory unit 202, the importance degree of the service. Also, the importance degree calculation unit 203 calculates the importance degree of the information service recipient from at least either one of: an amount of a conract of the information service recipient, a number of years during the contract continues and an accumulated amount of contract amount. For example, these importance degrees are calculated as a weighted sum of the rank and the amount of money of a plurality of SLA's which are linked to the information service.

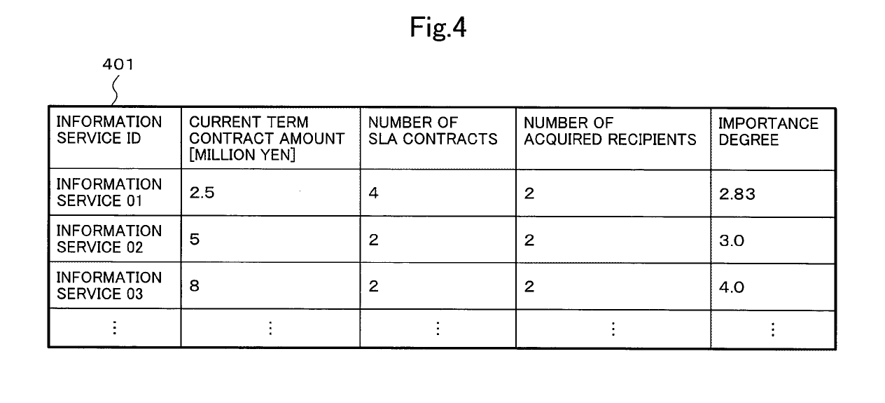

FIG. 4 shows a table 401 related to the importance degree of the information services. Numerical values entered in a column of “importance degree” of FIG. 4 indicate the importance degree calculated as a weighted sum of: a current term contract amount, a number of SLA contracts and a number of acquired recipients (a number of acquired service recipients) for each information service. For example, for an information service 01, the importance degree is calculated by an arithmetic expression as importance degree=2.5×a+4×b+2×c (where a, b and c are weights of each element and it is assumed that a+b+c=1). In this expression, suppose a=⅓, b=⅓ and c=⅓, then the importance degree will be, by the calculation of 2.5/3+4/3+2/3=7.5/3÷2.83, approximately 2.83.

Similarly, for an information service 02, the importance degree=5/3+2/3+2/3=3.0 and for an information service 03, the importance degree=8/3+2/3+2/2=4.0. Also, the importance degree of the information service recipient is calculated as a weighted sum of: a rank of the SLA which the information service recipient concerned has contracted, a rank of the information service concerned, and an amount of contract.

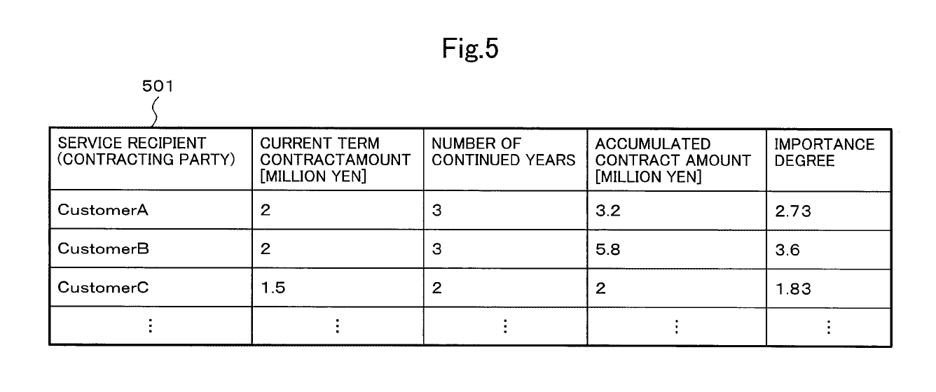

FIG. 5 shows a table 501 related to the importance degree of service recipients. For example, for CustomerA, the importance degree is calculated by an arithmetic expression as importance degree=2×a+3×β+3.2×y (where α, β and γ are weights of each element and it is assumed that α+β+γ=1). In this expression, suppose α=β=γ=⅓, then the importance degree will be, by the calculation of importance degree=2/3+3/3+3.2/3=8.2/3÷2.73, approximately 2.73. Similarly, by the calculation of importance degree=2/3+3/3+5.8/3=10.8/3=3.6, the importance degree will be 3.6 for CustomerB. Also, and similarly, by the calculation of importance degree=1.5/3+2/3+2/3=5.5/3÷1.83, the importance degree will he approximately 1.83 for CustomerC.

The information acquisition unit 205 collects in real time a measurement value 206 of a monitoring index which is set to be acquired in relation to the CI and the information service which constitute the system which is a monitoring target. And the information acquisition unit 205 refers to the information of the service information memory unit 202, and determines whether there is a problem with the measurement value. Also, in case there is a problem in the previous determination, the information acquisition unit 205 determines how big a size of the problem is. Many of the SLA's are linked via corresponding information service to the CI's which constitute the information service. However, there are also cases where the SLA's are linked to the CI's directly. Such a structure of data is reflected in registration information for the service information memory unit 202.

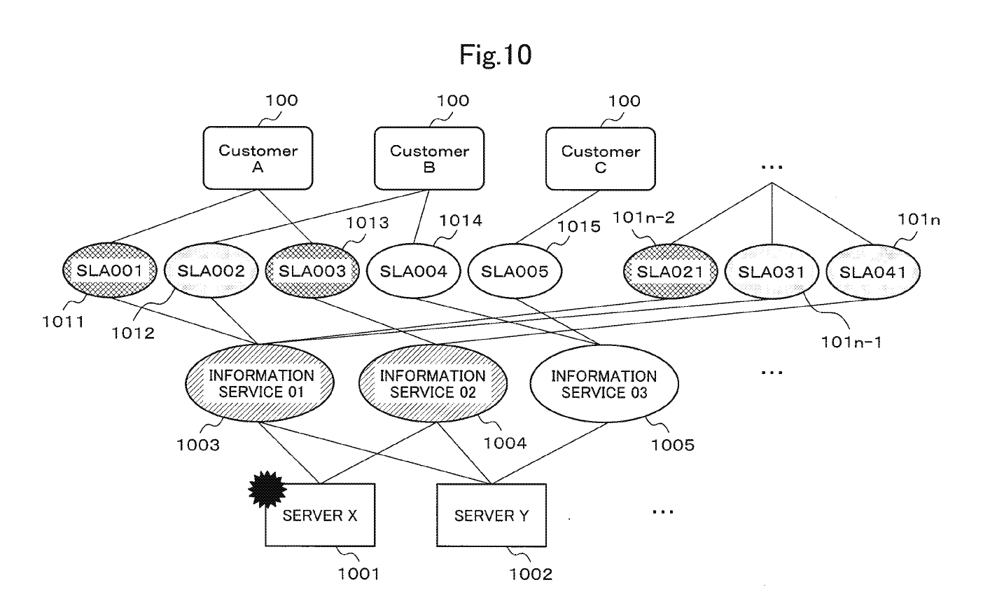

FIG. 10 shows an exemplary structure of the CI's according to this exemplary embodiment. In this structure, suppose that a problem occurs in a server X 1001, and performance level of the information services 01 and 02 (hatched ovals 1003 and 1004) deteriorated. Then, depending on the conditions of SLA's 1011-101n which are linked to them, a situation in which measurement values related to the index of monitoring target may not satisfy these conditions can happen. In this case, the monitoring target violates the SLA. In FIG. 10, SLA's 1011, 1013 and 101n-2 of which oval area is hatched by right and left oblique lines (slant lattice) are SLA's which are in violation. On the other hand. SLA's 1012, 101n-1 and 101n which are dot hatched are SLA's which, in case the monitoring target is left unattended, have possibility to be in violation.

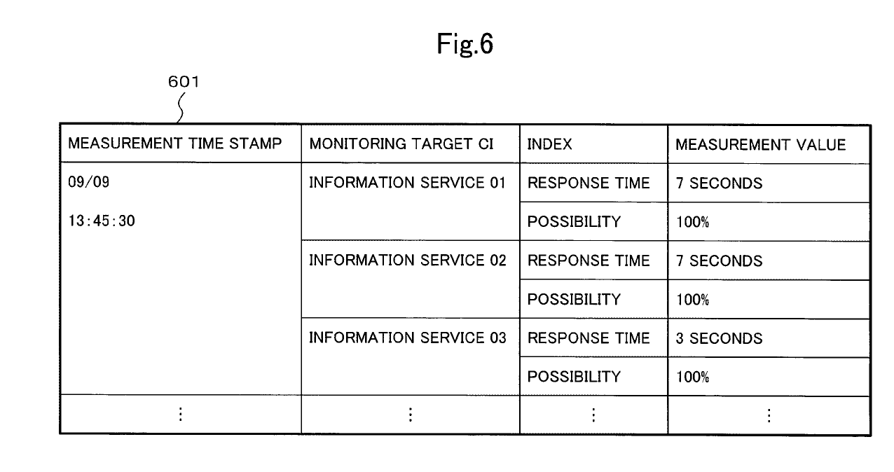

FIG. 6 shows a table 601 which recorded the measurement data related to each index of the monitoring target CI's which is an input to the information acquisition unit 205 in a column of “measurement value”. In this table, a case where a response time and an availability regarding each monitoring target CI at a certain measurement time are indices of measurement target is indicated. Further, the availability is generally obtained as a ratio of an actual operating time and a planned operating time of the information service. In this example, it is supposed that the planned operating time in each information service is set in advance. The information acquisition unit 205 calculates, after determining the system operating status by measuring the actual operating time, the operating time internally. The information acquisition unit 205 calculates the availability from this calculated numerical value.

Here, referring to FIG. 3, SLA_{—}001 specifies a condition which should be observed that a response time of the information service 01 is within 5 seconds. In contrast, to the condition in the measurement data of FIG. 6, the measurement value of the response time related to the information service 01 is 7 seconds. This measurement value violates the SLA_{—}001. On the other hand, since SLA_{—}002 sets the condition that the response time is within 10 seconds, the measurement value of the monitoring target will not be in violation. Also, referring to FIG. 3, the SLA_{—}001 specifies a condition which should be observed that an availability of the information service 01 is no smaller than 99.9%. In contrast, in the measurement data of FIG. 6, the availability related to the information service 01 is 100%, and this result does not violate the SLA_{—}001. That is, since (SLA value)<=(actual measurement value), the result is not in violation. In case the measurement data of the availability related to the information service 01 is supposed to be 90%, since (SLA value)<=(actual measurement value) does not hold, the result will be in violation.

On the other hand, there is a case where, regarding each index item of the SLA's which the information service or the service recipient contracted, SLA's which are not in violation yet may also result in violation in the future. This case is a case where, because of a problem which occurred in the CI being left unattended, the SLA which is related to this problem by a structure of the CI becomes in violation. In case of this exemplary embodiment comparing the table 301 of FIG. 3 and the measurement data 601 of FIG. 6, the SLA_{—}002 is not in violation at this moment. However, in FIG. 10, the information service 01 of which the service level deteriorates is related to the server X. Accordingly, in case the problem on the server X is left unattended, the performance of the information service 01 deteriorates further. In such a case, there is a possibility that theSLA_{—}002 may become in violation. Accordingly, the display image generation unit 204 sets the SLA_{—}002, as an SLA with a possibility that a violation will occur in the future, to in danger” which is a different status from “in violation” which is the status already in violation.

SLA_{—}004 and 005 are not related to the information service 01 nor 02. Accordingly, even if the problem on the server X is left unattended and becomes worse, the SLA_{—}004 and 005 are not linked to the service on which this problem influences. Accordingly, the display image generation unit 204 classifies the status of the SLA_{—}004 and 005 separately from the status of “in violation” and “in danger” and sets it to the status “no problem”.

In other words, in case there exists an SLA of which the actual measurement value does not satisfy the SLA value and which is in violation, the display image generation unit 204 specifies the information service which is in an upper stream (at lower side in FIG. 10) of the SLA and the problem server in an upper stream of the information service. Further, display image generation unit 204 specifies the information service in the lower stream of the problem server and the SLA in a lower stream of the information service. Even if the actual measurement value satisfies the SLA value, the display image generation unit 204 evaluates this SLA as “in danger”.

The display image generation unit 204 ranks them in three ways as “in violation”, “in danger” and no problem” as mentioned above for each of all the SLA's. The display image generation unit 204 displays them all together for each of the information service or each of the service recipient.

The display image generation unit 204 refers to the information outputted from the service information memory unit 202, the importance degree calculation unit 203 and the information acquisition unit 205. And the display image generation unit 204 generates image data for displaying the importance degree visually for the service or the service recipient. Also, the display image generation unit 204 generates image data for displaying the information such as the performance quality, the SLA observation status and its degree, and the contract size of the service or the service recipient visually together with the importance degree. When such image data is generated, a user can grasp at a glance information such as an order of priority related to the service or the service recipient and presence or absence or degree of the problem occurrence.

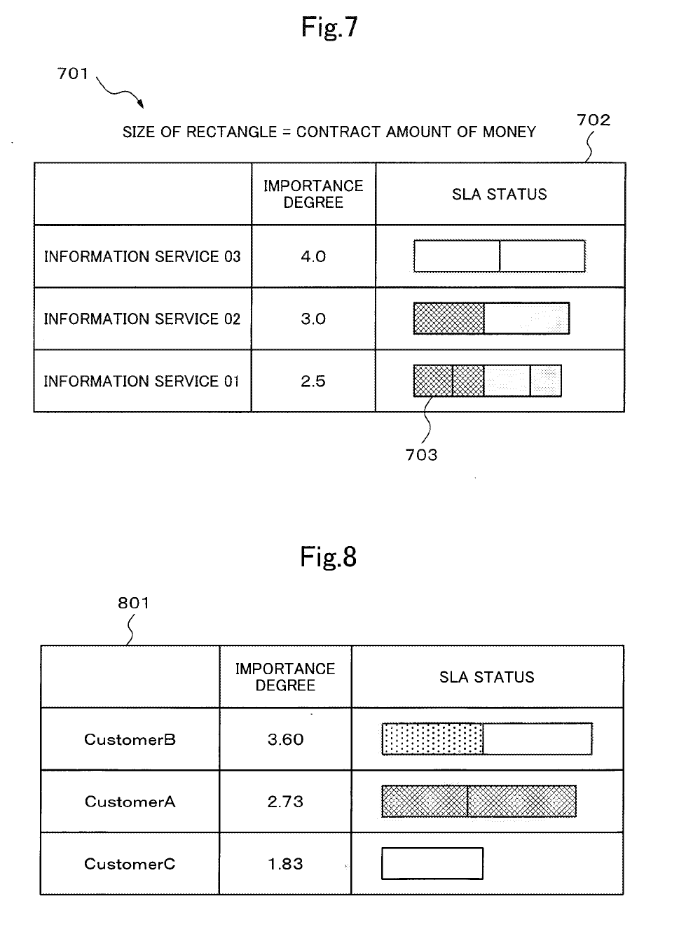

FIG. 7 and FIG. 8 show examples of display of the violation status of the SLA and the importance degree of the information service. Referring to FIG. 4 which is the output of the importance degree calculation unit 203, the importance degrees of the information services 01, 02 and 03 are 2.83, 3.0 and 4.0. FIG. 7 displays these services in order of the importance degree. Further, FIG. 7 indicates an SLA violation status 702 for each service which is the result of the reffering of measurement data 601 acquired by information acquisition unit 205, by a graph.

One rectangle of the SLA violation status 702 indicates one SLA. A rectangular area hatched by right and left oblique lines indicates “in violation”, a dotted area indicates “in danger” and no color indicates “no problem” respectively. Also, as for rectangles of the SLA violation status 702 of FIG. 7, entire size corresponds to the amount of contract of the respective SLA's. Therefore, the rectangle is displayed large for the SLA with large amount of contract.

For example, a rectangular area 703 shows the SLA_{—}001 linked to the information service 01. The entire rectangle of the rectangular area 703 is set to a size (length) corresponding to the amount of contract of the SLA_{—}001, 10,000,000 yen. Also, referring to FIG. 10, SLA_{—}001 002, 021 and 031 are linked to the information service 01. Among them, the SLA_{—}001 and 021 are in violation of the respective observation conditions. The SLA_{—}002 and 031, are exposed to a danger that the observation conditions will become in violation. For this reason, in the entire rectangular area of FIG. 7, about half is hatched by the right and left oblique lines, and about half is hatched by dots.

On the other hand, FIG. 8 displays the importance degree and the SLA violation status of the service recipient. FIG. 8 displays each service recipient in order of the importance degree order by referring to FIG. 5. Further, FIG. 8 indicates the SLA violation status shown in FIG. 3 displays for each service recipient by a graph. Although this exemplary embodiment indicates the SLA violation status in a bar graph-like one, expression methods may be a pie chart or other general graphs.

<<Operation>>

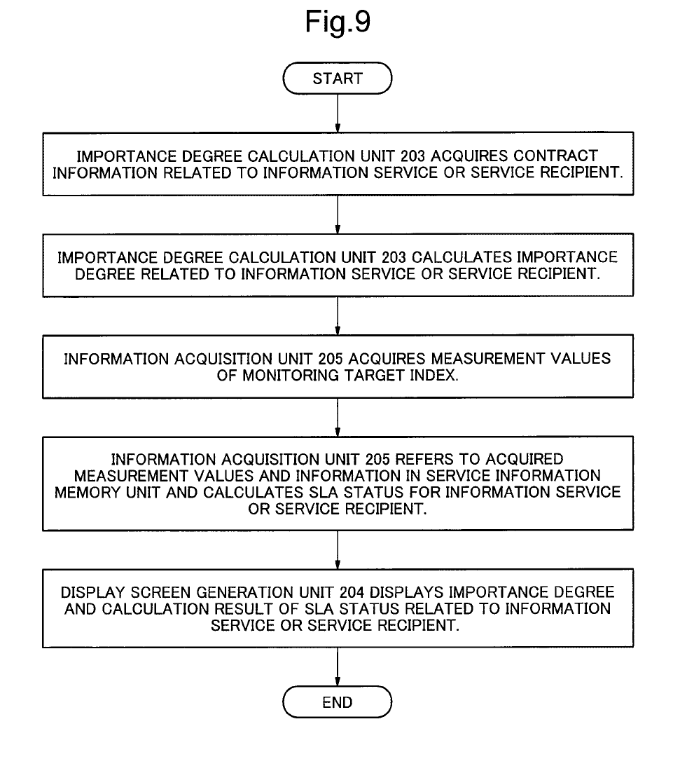

Next, processing performed in this exemplary embodiment will be described with reference to FIG. 9. FIG. 9 is a flow chart indicating an example of processing performed by the importance degree calculation unit 203, the display image generation unit 204 and the information acquisition unit 205 in FIG. 2. First, the importance degree calculation unit 203 acquires the information related to the service from the service information memory unit 202 (S901). Next, the importance degree calculation unit 203 calculates the importance degree (table 401 of FIG. 4 or table 501 of FIG. 5) of the information service or the service recipient (S903).

Next, the information acquisition unit 205 acquires the measurement values of the indices of the monitoring target CI's (measurement data 601 of FIG. 6) (S905). Next, the information acquisition unit 205 refers to the acquired measurement values and the information in the service information memory unit 202, calculates the SLA violation status for the information service or the service recipient (S907). Finally, the display image generation unit 204 draws the result outputted from the importance degree calculation unit 203 and the information acquisition unit 205 on a display (S911).

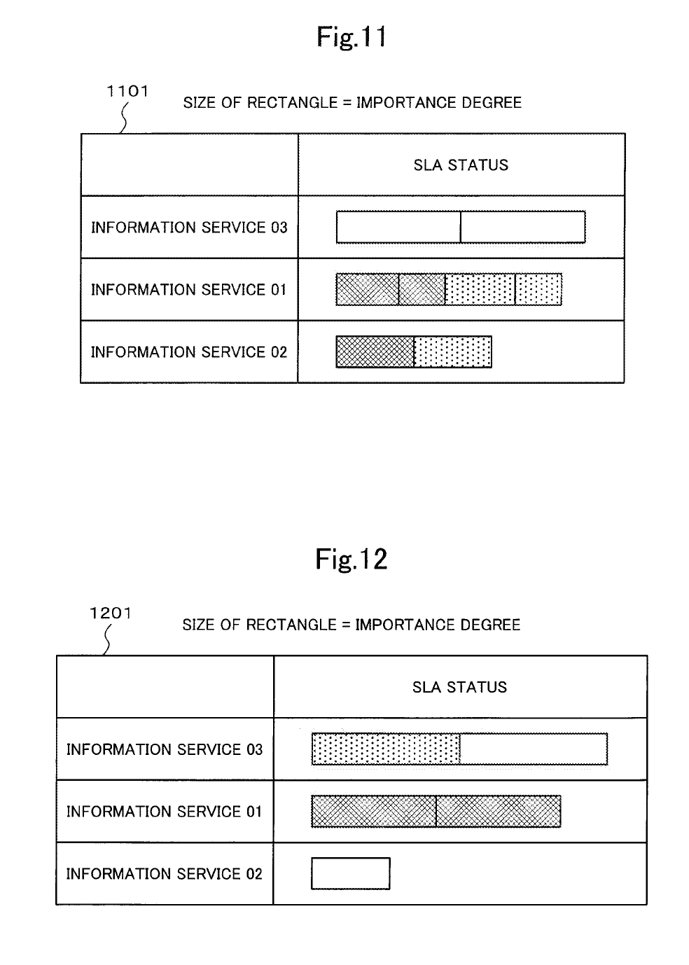

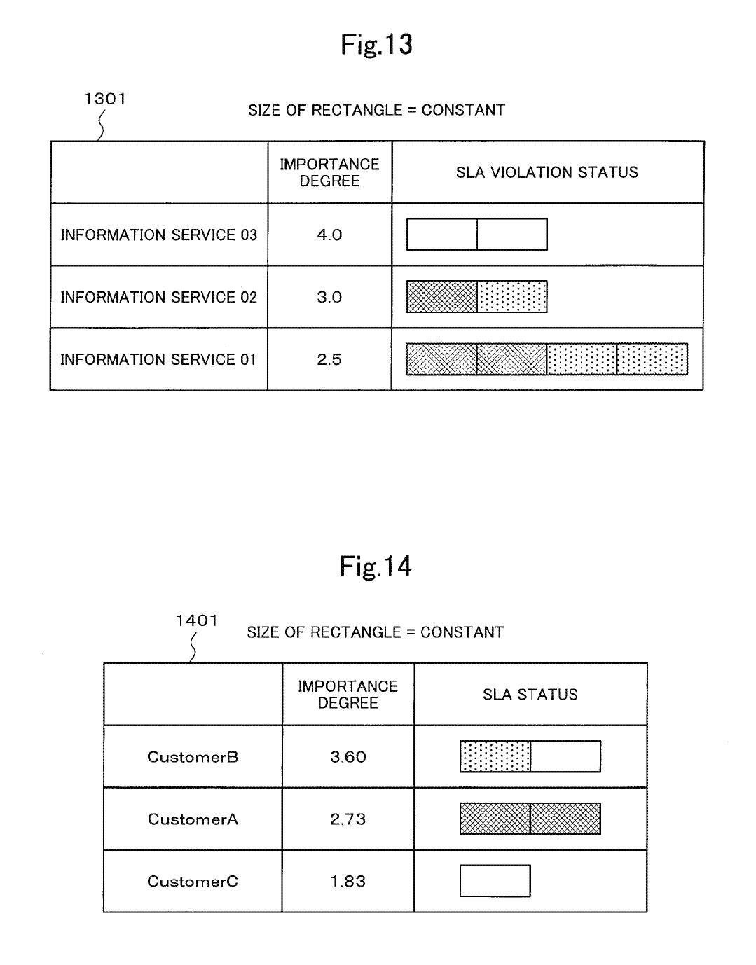

FIG. 11 and FIG. 12 are figures indicating other examples of a display 1101 and 1201. In these figures, the importance degree shown in FIG. 7 is reflected to the total of the area of the rectangle in the graph of the SLA violation status. Also, as other variations, FIG. 13 and FIG. 14 display the SLA violation status together with the importance degree by making the area of the respective rectangles corresponding to each SLA constant. Further, FIGS. 7, 8, 11, 12, 13 and 14 are only examples of this exemplary embodiment respectively, and this exemplary embodiment can adopt other display forms.

### Effect of the Second Exemplary Embodiment

By this exemplary embodiment, the information service provider can confirm with priority the SLA violation status of the information service or the service recipient with high importance degree preferentially from a standpoint of business. Also, the information processing device of this exemplary embodiment can present plainly a degree of the SLA violation which occurred to the important information service or its recipient. Also, the information processing device of this exemplary embodiment can present plainly to the service provider to which level the influence is when the information processing device is left unattended. In particular, even in case there is a plurality of SLA's linked to the important information service or the service recipient, the information processing device of this exemplary embodiment supports the user to grasp the situation of the problem quickly. This is because the information processing device of this exemplary embodiment displays overall importance degree visually when there exists a problem. The importance degree calculation unit according to this exemplary embodiment can be applied suitably for the use to grasp failure status in the operation monitoring field correctly and performs failure handling. In particular, in case a plurality of failures occur simultaneously under the large scale system environment, the importance degree calculation unit of this exemplary embodiment is useful.

### Other Embodiments

As above, the exemplary embodiments of the present invention have been explained in detail. A system or a device which combined separate features included in the respective exemplary embodiments arbitrarily is included in the category of the present invention.

Also, the present invention can be applied to a system including a plurality of devices. Also, the present invention can be applied to a device of a single unit. Further, the present invention can also be implemented by a processor of a computer executing an information processing program which realizes the function of the exemplary embodiment. In this case, for a system or a device for which the present invention is implemented, the implementation is possible to be operated directly or remotely. Accordingly, a program installed in a computer, a medium which stored the program and a WWW (World Wide Web) server which makes the program to be downloaded in order to realize the function of the present invention by the computer are all included in the category of the present invention.

### Other Expressions of the Exemplary Embodiments

Although a part or all of the exemplary embodiments mentioned above can also be described as following supplementary notes, they are not limited to the followings.

(Supplementary Note 1)

An information processing device for notifying a providing state of an information service, and

the information processing device characterized in that it includes: an acquisition means for acquiring measurement values regarding monitoring target items relating to the information service; an importance degree calculation means for calculating an importance degree of the information service or an information service recipient; a determination means for comparing a plurality of conditions required in relation to the monitoring target items relating to the information service with the measurement values and determining a degree of violation of the conditions; and an image generation means for generating an image indicating the degree of violation of the conditions for each different importance degree of the information service or the information service recipient.

(Supplementary Note 2)

The information processing device described in the supplementary note 1 characterized in that the image generation means generates an image indicating the degree of violation of the conditions for each of the information service.

(Supplementary Note 3)

The information processing device described in the supplementary note 1 characterized in that the image generation means generates an image indicating the degree of violation of the conditions for each recipient of the information service.

(Supplementary Note 4)

The information processing device described in the supplementary notes 1, 2 or 3 characterized in that the importance degree calculation means calculates the importance degree of the information service from at least either one of: a contract rank of the information service concerned, amount of money and a number of contracts.

(Supplementary Note 5)

The information processing device described in either one item of the supplementary notes 1 to 4 characterized in that the importance degree calculation means calculates the importance degree of the information service recipient from at least one of a contract amount, a number of continued contract years and an accumulated contract amount of the information service recipient.

(Supplementary Note 6)

The information processing device described in either one item of the supplementary notes 1 to 5 characterized in that the image generation means generates an image indicating both of the importance degree of the information service or the information service recipient and the degree of violation of the conditions.

(Supplementary Note 7)

The information processing device described in either one item of the supplementary notes 1 to 6 characterized in that the image generation means displays the importance degree of the information service or the information service recipient by a graph.

(Supplementary Note 8)

The information processing device described in either one item of the supplementary notes 1 to 7 characterized in that, in case the monitoring target items relating to a first information service is determined to be in violation of the conditions, the determination means specifies, by analyzing the monitoring target items concerned, one which is a second information service different from the first information service and which has a possibility to be in violation of the conditions later.

(Supplementary Note 9)

An information processing method for notifying a providing state of an information service, and the data processing method characterized in that it includes: a step for acquiring measurement values regarding monitoring target items relating to the information service; a step for calculating an importance degree of the information service or an information service recipient; a step for comparing a plurality of conditions required in relation to the monitoring target items relating to the information service with the measurement values and determining a degree of violation of the conditions; and a step for generating an image indicating the degree of violation of the conditions for each different importance degree of the information service or the information service recipient.

(Supplementary Note 10)

An information processing program for notifying a providing state of an information service, and the information processing program characterized in that it makes a computer execute: a step for acquiring measurement values regarding monitoring target items relating to the information service; a step for calculating an importance degree of the information service or an information service recipient; a step for comparing a plurality of conditions required in relation to the monitoring target items relating to the information service with the measurement values and determining a degree of violation of the conditions; and a step for generating an image indicating the degree of violation of the conditions for each different importance degree of the information service or the information service recipient.

Although the present invention has been described with reference to the exemplary embodiments as above, the present invention is not limited by the exemplary embodiments mentioned above.

This application claims priority based on Japanese Patent Application 2010-260167 filed on Nov. 22, 2010 and the disclosure thereof is incorporated herein in its entirety.

### DESCRIPTION OF CODES

101 Measurement value acquisition unit

102 Importance degree calculation unit

103 Condition violation determination unit

104 Notification image generation unit

201 Input/output unit

202 Service information memory unit

203 Importance degree calculation unit

204 Display image generation unit

205 Information acquisition unit

1-10. (canceled)

11. An information processing device comprising:
an acquisition unit which acquires measurement values regarding monitoring target items relating to an information service;
an importance degree calculation unit which calculates an importance degree of said information service or of a recipient of said information service;
a determination unit which compares a plurality of condition required in relation to said monitoring target items relating to said information service with said measurement values and determining a degree of violation of the conditions; and
an image generation unit which generates an image indicating said degree of violation of the conditions for each different importance degree of said information service or said recipient of said information service.

12. The information processing device according to claim 11, wherein said image generation unit generates an image indicating said degree of violation of the conditions for each of said information service.

13. The information processing device according to claim 11, wherein said image generation unit generates an image indicating said degree of violation of the conditions for each recipient of said information service.

14. The information processing device according to claim 11, wherein said importance degree calculation unit calculates the importance degree of said information service from at least either one of: a contract rank of the information service concerned, amount of money, and a number of contracts.

15. The information processing device according to claim 11, wherein said importance degree calculation unit calculates an importance degree of said recipient of said information service from at least either one of: contract amount of said recipient of said information service, a number of continued contract years and an accumulated contract amount.

16. The information processing device according to claim 11, wherein said image generation unit generates an image indicating both of the importance degree of said information service or of said recipient of said information service and said degree of violation of the conditions.

17. The information processing device according to claim 11, wherein said image generation unit displays the importance degree of said information service or importance degree of said recipient of said information service by a graph.

18. The information processing device according to claim 11, wherein if said monitoring target items relating to a first information service is determined to be in violation of the conditions, said determination unit specifies, by analyzing the monitoring target items, one which is a second information service different from the first information service and which has a possibility to be in violation of the conditions later.

19. An information processing method comprising:
acquiring measurement values regarding monitoring target items relating to an information service;
calculating an importance degree of said information service or of a recipient of said information service;
comparing a plurality of conditions required in relation to said monitoring target items relating to said information service with said measurement values and determining a degree of violation of the conditions; and
generating an image indicating said degree of violation of the conditions for each different importance degree of said information service or of the recipient of said information service.

20. A non-transient computer-readable medium which stores information processing program which cause a computer to execute:
processing for acquiring measurement values regarding monitoring target items relating to an information service;
processing for calculating an importance degree of said information service or an importance degree of a recipient of an information service;
processing for comparing a plurality of conditions required in relation to said monitoring target items relating to said information service with said measurement values and determining a degree of violation of the conditions; and
processing for generating an image indicating said degree of violation of the conditions for each different importance degree of said information service or of the recipient of said information service.

21. An information processing device comprising:
an acquisition means for acquiring measurement values regarding monitoring target items relating to an information service;
an importance degree calculation means for calculating an importance degree of said information service or of a recipient of said information service;
a determination means for comparing a plurality of condition required in relation to said monitoring target items relating to said information service with said measurement values and determining a degree of violation of the conditions; and
an image generation means for generating an image indicating said degree of violation of the conditions for each different importance degree of said information service or of the recipient of said information service.
